(19) United States
(12) Patent Application Publication
(10) Pub. No.: US 2011/0237339 A1
(43) Pub. Date: Sep. 29, 2011

(54) Method and apparatus for playing pool

(76) Inventor: Stewart C. Gardner, North attleboro, MA (US)

(21) Appl. No.: 12/798,085

(22) Filed: Mar. 29, 2010

(51) Int. Cl. A63D 15/00; G06F 19/00

(52) U.S. Cl. 473/20; 473/1; 700/91

(57) ABSTRACT

A method and apparatus for playing pool on a pool table is disclosed. A raised stand is located on the pool table and pool balls are hit into an indentation on the raised stand. For example, a plurality of pool balls is arranged in a starting position on the playing surface of the pool table. The plurality of pool balls is comprised of an object ball and a plurality of different sets of pool balls. Players alternate turns wherein each player attempts to hit balls from a set of pool balls assigned to that player into pockets in the pool table using a pool cue and a cue ball. The game ends when the object ball is hit into an indentation on a top level of the raised stand once a player has hit all of their assigned balls into the pockets

### FIELD OF THE INVENTION

The present invention relates generally to a method and apparatus for playing new pool (billiard) games, and more particularly, to new pool games which incorporate a raised stand located on the playing surface of a pool table.

### BACKGROUND OF THE INVENTION

The origination of pocket billiards can be traced back to Europe in the 1500's. Typically, pocket billiards is played on a rectangular table with a plurality of drop pockets arranged around the playing surface. For example, the pool table 10 can have six pockets 12 arranged around the periphery of the playing surface 24, one in each corner and two on the sides, as illustrated in FIG. 1. Standard pool games use a plurality of pool balls including a cue ball, wherein a player strikes the cue ball with a pool cue in an attempt to hit one of the pool balls into a pocket.

Over the years, several pool games have become very popular, namely 8-ball and 9-ball. In 8-ball, the pool balls are divided into two sets, 7 low numbered balls or “solids” and 7 high number balls or “strips”. In addition, there is a an object ball, i.e., the 8-ball. The basic format of this game is that each player is assigned either solids or strips and the player attempts to hit all of his/her assigned balls into the pockets of the pool table. Once a player has successfully hit all of his/her assigned balls into the pockets, the player attempts to hit the 8-ball into a previously selected pocket. The game continues until a player successfully makes the 8-ball in the selected pocket.

9-ball uses 9 balls numbered 1 through 9. The balls are hit in rotation, meaning that they must be hit in numerical order starting with the 1-ball. However, the balls do not need to be pocketed in sequence. As long as the cue ball hits the ball with the correct number first, any ball including the 9-ball may be sunk and the player is allowed to continue their turn. A player wins by legally sinking the 9-ball into a pocket at any point during the game.

After playing 8-ball and 9-ball over and over again, some players will want some variety in the games they play so they will look for new games to play. Over the past decades, people have devised many variations of known pool games. One problem with many of these new games is that pool players consider the games to be too gimmicky or introduce too much luck into the game which goes against the basic principles of pool which require skill and concentration.

Thus, there is a need for new pool games and apparatus which overcomes the problems cited above.

### SUMMARY OF THE INVENTION

It is therefore a feature and advantage of the present invention to provide new pool games and apparatus to be used in these games which require skill and strategy.

According to one aspect of the invention, a method for playing a game on a pool table is disclosed. The method is comprising of the steps of: placing a plurality of pool balls in a starting position on the playing surface of the pool table, wherein the plurality of pool balls is comprised of an object ball and a plurality of different sets of pool balls; alternating turns between a plurality of players, wherein each player attempts to hit balls from a set of pool balls assigned to that player into pockets in the pool table using a pool cue and a cue ball; and hitting the object ball into an indentation on a top level of a raised stand located on the playing surface of the pool table once a player has hit all of their assigned balls into the pockets, wherein the game ends when the object ball comes to rest in the indentation on the raised stand.

According to another aspect of the invention, a gaming device to be used on a playing surface of a pool table for playing a game of pool is disclosed. The gaming device comprises: a raised stand located on the playing surface of the pool table, the raised stand having sloped sides that lead from the playing surface up to a top level, wherein the top level comprises an indentation in which a pool ball can come to rest after advancing up the sloped sides.

According to another aspect of the invention, a pool table is disclosed. The pool table comprises: a substantially flat playing surface; a raised bumper system surrounding the flat playing surface; and at least one raised stand on the playing surface, wherein the at least on raised stand has sloping sides that lead up from the playing surface to a top level, wherein the top level comprises an indentation in which a pool ball can come to rest after advancing up the sloping sides

According to another aspect of the invention, a method for playing a game on a pool table is disclosed. The method is comprised of the steps of: placing a plurality of pool balls in a starting position on a playing surface of the pool table; and alternating turns between a plurality of players, wherein each player attempts to hit a ball from the plurality of pool balls into an indentation on at least one raised stand located on the playing surface of the pool table by hitting a cue ball with a pool cue.

According to another aspect of the invention, a computer readable medium storing code for simulating a pool game is disclosed. The code comprises: code for placing a plurality of pool balls in a starting position on the playing surface of the pool table, wherein the plurality of pool balls is comprised of an object ball and a plurality of different sets of pool balls; code for alternating turns between a plurality of players, wherein each player attempts to hit balls from a set of pool balls assigned to that player into pockets in the pool table using a pool cue and a cue ball; and code for hitting the object ball into an indentation on a top level of a raised stand located on the playing surface of the pool table once a player has hit all of their assigned balls into the pockets, wherein the game ends when the object ball comes to rest in the indentation on the raised stand.

According to another aspect of the invention, a computer readable medium storing code for simulating a pool game is disclosed. The code comprises: code for placing a plurality of pool balls in a starting position on a playing surface of the pool table; and code for alternating turns between a plurality of players, wherein each player attempts to hit a ball from the plurality of pool balls into an indentation on at least one raised stand located on the playing surface of the pool table by hitting a cue ball with a pool cue.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will now be described, by way of example, with reference to the accompanying drawings, wherein:

FIG. 1 illustrates a prior art pool table;

FIG. 2 illustrates a perspective view of a raised stand according to one embodiment of the invention;

FIG. 3 illustrates a top view of a raised stand according to one embodiment of the invention;

FIG. 4 illustrates a side view of a raised stand according to another embodiment of the invention;

FIG. 5 illustrates a raised stand with a plurality of indentations according to another embodiment of the invention;

FIG. 6 illustrates a multilevel raised stand according to another embodiment of the invention;

FIG. 7 illustrates a pool table with a raised stand according to one embodiment of the invention;

FIG. 8 illustrates a pool table with a raised stand according to another embodiment of the invention,

FIG. 9 illustrates a pool table with a raised stand according to another embodiment of the invention,

FIG. 10 illustrates a large raised stand according to another embodiment of the invention;

FIG. 11 illustrates a pool table according to one embodiment of the invention;

FIG. 12 illustrates a pool table according to one embodiment of the invention,

FIG. 13 illustrates a computer system according to one embodiment of the invention;

FIG. 14 illustrates a computer readable medium according to one embodiment of the invention; and

FIG. 15 illustrates a computer readable medium according to one embodiment of the invention.

### DETAILED DESCRIPTION OF PREFERRED EMBODIMENTS OF THE INVENTION

According to one embodiment of the invention, at least one raised stand is placed or attached to the playing surface of a pool table. The goal of the new pool games described below is to hit one or more pool balls into an indentation on the raised stand or stands. The specifics of the raised stands will now be described followed by a description of some of the new pool games which can be played using the raised stand or stands.

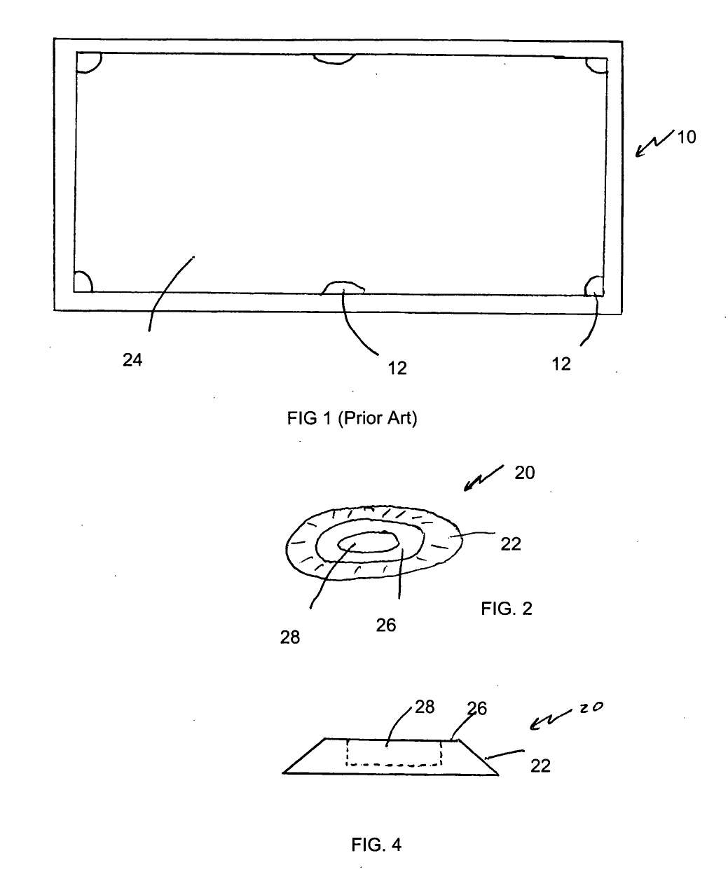

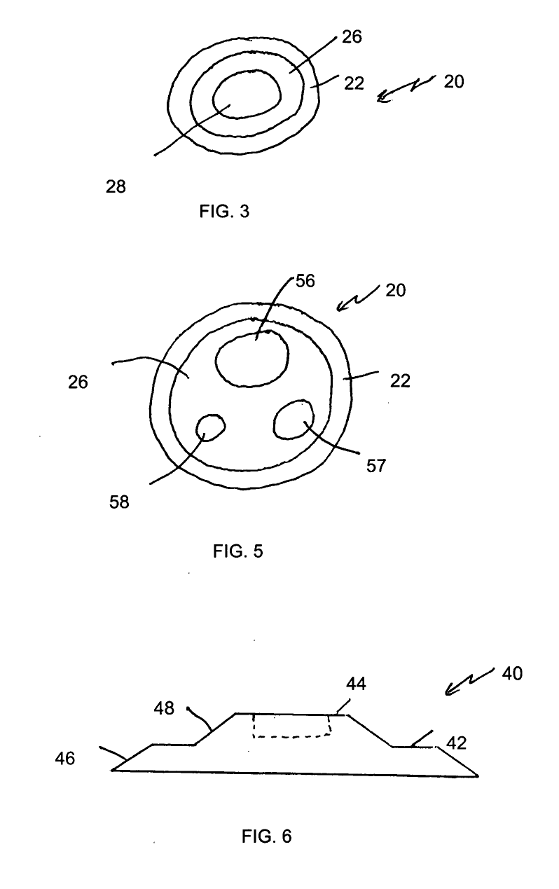

As illustrated in FIG. 2, the raised stand 20 has sloping sides 22 which lead up from the playing surface of a pool table 24 to a top level 26. The top level 26 has an indentation 28 in which a pool ball moving at the correct speed may come to rest. FIG. 3 illustrates the raised stand 20 as viewed from above and FIG. 4 illustrates the raised stand 20 as viewed from the side. As illustrated in FIG. 2, the raised stand can be substantially circular in shape, but the invention is not limited thereto. For example, the raised stand can have a shape that is substantially similar to a circle, triangle, square, hexagon, pentagon, or any other shape.

The indentation 28 can be a dip in the top level 26 with sloping sides or the indentation 28 can be a hole with substantially vertical sides as illustrated in FIG. 2. The hole may be substantially circular or square, but the invention is not limited thereto. In addition, the indentation 28 may take up a portion of the top level or the indentation can take up substantially all of the top level as illustrated in FIG. 2.

The raised stand 20 may be constructed with various diameters and height. Furthermore, the indentations can have various diameters and depths, wherein the larger and deeper the indentation, the easier it is for a ball to come to rest in the indentation. According to one embodiment of the invention, the raised stand 20 has an outer diameter of approximately 4 inches with a substantially circular hole approximately 2.75 inches in diameter. According to one embodiment of the invention, the raised stand 20 has an outer diameter of approximately 5.5 inches with a substantially circular hole approximately 4 inches in diameter. According to one embodiment of the invention, the raised stand 20 has an outer diameter of approximately 7 inches with a substantially circular hole approximately 5.5 inches in diameter. According to one embodiment of the invention, the raised stand 20 has an outer diameter of approximately 13.5 inches with a substantially circular hole approximately 12 inches in diameter. The raised stands 20 described above can have heights ranging from 0.125 to 1.5 inches but the invention is not limited thereto.

The raised stand 20 can be constructed out of many materials comprising at least one of metal, metal composite, plastic, wood, stone, glass, resin and/or rubber, but the invention is not limited thereto. The raised stand 20 can also comprise lights and/or sound making devices, wherein the lights flash and/or the sound making devices make sounds when a ball comes to rest in an indentation on the raised stand 20. For example, the weight of the ball (or composition of the ball) can close a switch which completes a circuit which activates the lights and/or sound devices, but the invention is not limited thereto. The lights and/or sound devices can be arranged in any pattern and can be composed of any number of lights and/or sound devices.

According to another embodiment of the invention, the raised stand 20 may have a plurality of indentations 56, 57, 58 on the top level 26, as illustrated in FIG. 5. The indentations can be of the same size or shape or can have different sizes or shapes. For example, the indentations 56, 57, 58 can have different diameters as illustrated in FIG. 5. Furthermore, a raised stand may have 2 or more levels, wherein sloped sides lead up from one level to the next. As illustrated in FIG. 6, the raised stand 40 has two levels 42 and 44. A first sloped side 46 leads up from the surface of the pool table to the first level 42 and a second sloped side 48 leads up from the first level 42 to the second level 44. In this embodiment, the raised stand has at least one indentation and one or more indentations can be located on one of the levels or a plurality of levels, but the invention is not limited thereto. In addition, a multilevel stand can be created by stacking single level stands of different size on top of each other, but the invention is not limited thereto.

The raised stands described above can be used to play a variety of new pool games. Some of these new pool games will now be described below but the invention is not limited thereto.

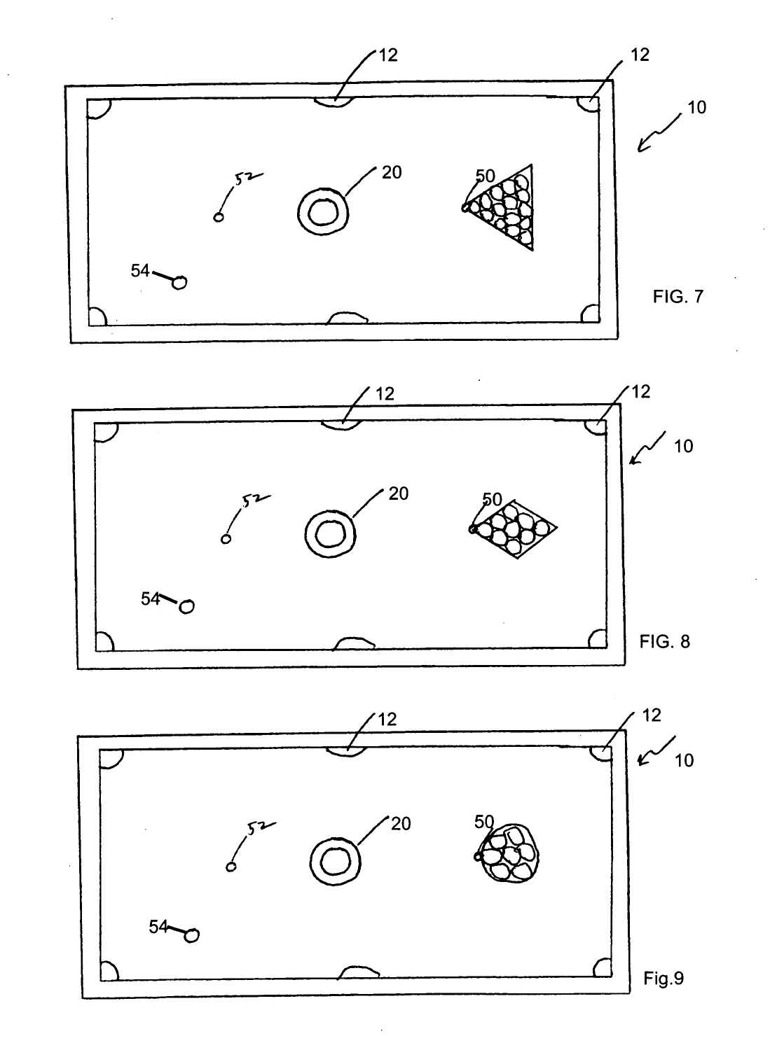

According to one embodiment of the invention, a single raised stand is used and is located on the playing surface of a pool table. For example, a raised stand 20 is placed approximately in the middle of the pool table 10 as illustrated in FIG. 7. Different sized raised stands can be used to change the difficulty of the game, wherein the difficulty of the game generally increases as the dimensions of the raised stand and the indentation are reduced.

The first set of games to be described are a variation of 8-ball with the incorporation of the raised stand into the game. To begin the game, a plurality of pool balls are placed (racked) in a starting position on a first spot 50, but the invention is not limited thereto. As illustrated in FIG. 7, the game begins with 15 balls and a cue ball. The 15 pool balls are racked using a triangular rack on the first spot 50. Alternatively, the game can begin with 9 balls racked with a diamond shaped rack on the first spot 50 as illustrated in FIG. 8. Alternatively, the game can begin with 7 balls racked by a circular rack on the first spot 50 as illustrated in FIG. 9. It will be understood by one skilled in the art that the balls can be racked in any location on the table in any configuration and the invention is not limited thereto. For example, the pool balls may be racked in such a manner that one or more of the pool balls are located on the raised stand 20.

In all of the versions of the game described above (using 15, 9 or 7 balls), the pool balls are divided into a plurality of sets. First, an object ball, for example, the 8-ball, is designated. The remaining even number of balls are then divided into two sets, for example, solids and strips. The object of this first set of games is to hit the object ball onto the raised stand with the correct speed so that the object ball comes to rest in the indentation on the raised stand. If the object ball is legally hit onto the raised stand and the object ball comes to rest in the indentation on the raised stand, the player who hit the object ball is declared the winner of the game.

To begin play, a player is selected to take the first shot, wherein the player hits the cue ball with a pool cue from behind the second spot 52 to break apart the racked pool balls. If one of the pool balls goes into a pocket during the first shot, the first player is awarded that set of balls and the other player is awarded the other set of balls. If more than a single ball is pocketed, the player is awarded the set of balls corresponding to the set with the most balls that went in the pockets. If no ball are pocketed or if the same number of balls from each set are pocketed, no set is awarded until the next ball is hit into a pocket. In the alternative, one of the sets of balls can be assigned to each player before play begins. If the object ball is hit into a pocket on the break, the object ball is placed on the first spot 50 and the game continues. If the object ball ends up in the indentation on the raised stand on the first shot, that player is declared the winner.

The players alternate turns hitting the cue ball in an attempt to hit their assigned balls into the pockets of the pool table. When a player hits one or more of their assigned balls into a pocket, the player receives another turn. Once the player has hit all of their assigned balls into the pockets of the pool table, the player then attempts to hit the object ball into the indentation in the raised stand 20. According to one embodiment of the invention, the player can hit the object ball directly with the pool cue when attempting to hit the object ball into the indentation. Alternatively, the player must hit the cue ball into the object ball to hit the object ball into the indentation in the raised stand. The first player to legally hit the object ball into the indentation on the raised stand is declared the winner of the game.

According to one embodiment of the invention, a player may attempt to hit the object ball onto the raised stand using the cue ball at any time during the game. If the player is successful in hitting the ball into the indentation in the raised stand, the player is declared the winner of the game.

According to one embodiment of the invention, any balls other than the object ball hit into the indentation in the raised stand can be considered as a scratch and the ball is placed on the first spot 50 and that player loses his turn. In the alternative, any ball hit into the indentation in the raised stand can be considered as pocketed and the ball is placed in a pocket and the player receives another turn.

According to another embodiment of the invention, when a player is attempting to hit the object ball into the indentation on the raised stand after pocketing all of their assigned balls, the object ball must come into contact with the raised stand or else the player is penalized. For example, the player may lose the game if the object ball does not hit the raised stand. Alternatively, the player must place one of their pocketed balls back on the first spot 50 if the object ball does not hit the stand. According to another embodiment of the invention, a player loses the game if the object ball is pocketed at any time during their turn.

According to another embodiment of the invention, a variation on the 9-ball game is disclosed incorporating the use of a raised stand. In regular 9-ball, players attempt to hit the balls in rotation, that is they must be targeted in numerical sequence starting with the one ball. It is important to note that the balls do not necessarily need to be pocketed in numerical sequence. As long as the correct ball is truck first by the cue ball, any ball can be pocketed and the player is awarded another turn. The game continues until a player pockets the 9-ball. According to this embodiment of the invention, instead of pocketing the 9-ball to win the game, the players must hit the 9-ball into the indentation in the raised stand to win the game. As in the traditional game, a player can win at any point in the game by successfully hitting the 9-ball into the indentation in the raised stand so long as the cue ball strikes the correct ball first. In another embodiment of the invention, the 9-ball can be stuck directly with the pool cue if all of the other balls have been pocketed.

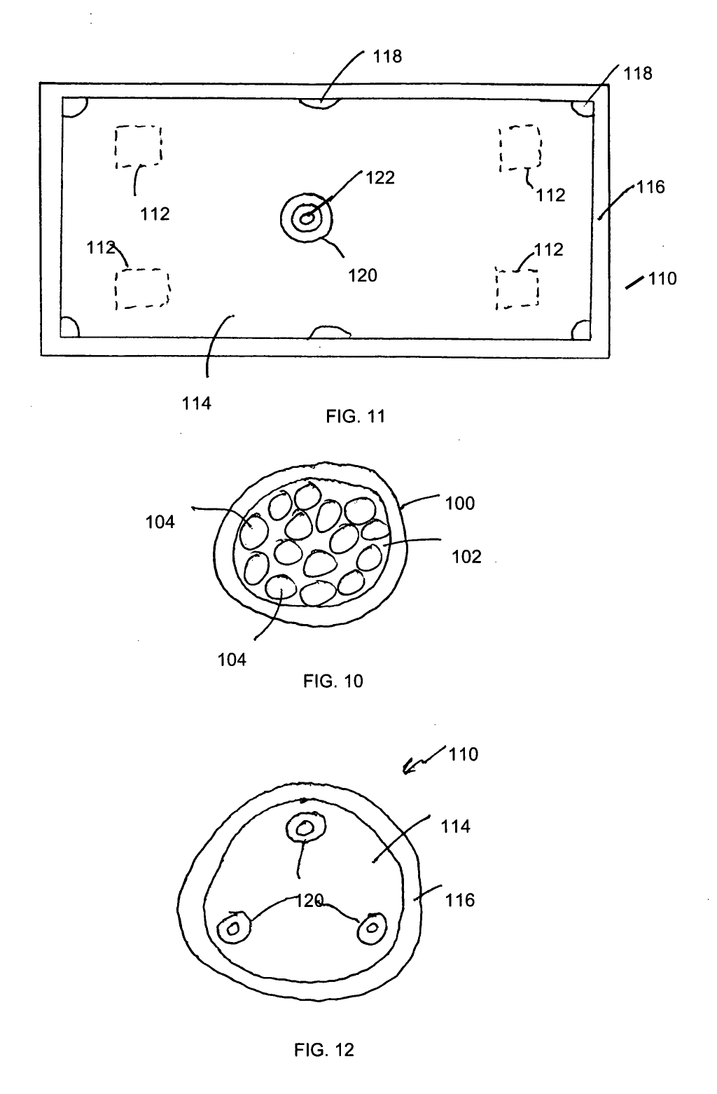

According to another embodiment of the invention, all of the pool balls must be hit into a single indentation in the raised stand. The traditional 8-ball and 9-ball game rules can be used except that the balls must be hit into the indentation on the raised stand rather than the pockets of the pool table. In one embodiment of the invention, the raised stand has an indentation 102 which is large enough to hold all of the pool balls 104 and the pool balls are not removed from the raised stand when they are successfully hit onto the raised stand as illustrated in FIG. 10.

According to another embodiment of the invention, the above described games can be played with a plurality of raised stands located on the surface of the pool table. The raised stands can have the same shape and size or have different shapes and sizes. In addition, raised stands may be placed near or on top of the pockets 12 of the pool table. In this embodiment, pool balls must be hit into the indentations on the raised stands rather than in the pockets 12. Furthermore, the object ball can be hit onto any of the raised stands or only onto a specific raised stand to win the game.

According to another embodiment of the invention, players can play a game where they are awarded points for successfully hitting pool balls into indentations on one or more raised stands. The raised stand 20 can have a plurality of different sized indentations as illustrated in FIG. 5, wherein a player receives different point values for hitting a pool ball into different sized indentations. For example, a player may receive 1 point for hitting a ball into the large indentation 56, 2 points for hitting a ball into the medium sized indentation 57, and 5 points for hitting a ball into the small hole 58. The players take turns hitting the pool balls using the cue ball into the indentations on the raised stand and the first player to total a predetermined number of points is declared the winner of the game. Alternatively, the same game can be played with a plurality of different sized raised stands with single or multiple indentations.

According to another embodiment of the invention, all of the games described above and obvious variations thereof can be played with a multilevel raised stand as illustrated in FIG. 6. Furthermore, the multilevel raised stand can have one or more indentations.

According to another embodiment of the invention, a new pool table design will now be described. As illustrated in FIG. 11, a pool table 110 has a base or a set of legs 112 on which a playing surface 114 is supported. The playing surface is surrounded by a series of bumpers 116 to keep the pool balls on the playing surface 114. The playing surface and the bumpers can be covered in felt but the invention is not limited thereto. A plurality of pockets 118 can be optionally located around the periphery of the playing surface 114, but the invention is not limited thereto. A raised stand 120 with at least one indentation 122 is provided on the playing surface 114. The raised stand 120 can be permanently attached or be detachable from the pool table 110, wherein the detachable raised stand is mounted in a mounting bracket in the playing surface 114. The raised stand can be screwed into or snapped or otherwise secured to the mounting bracket but the invention is not limited thereto. According to another embodiment of the invention, the pool table 110 can have a plurality of raised stands attached to the playing surface 114. The pool table and the playing surface can have any shape and size. For example, the pool table 110 can be rectangular in shape as illustrated in FIG. 11 or have a circular shape as illustrated in FIG. 12.

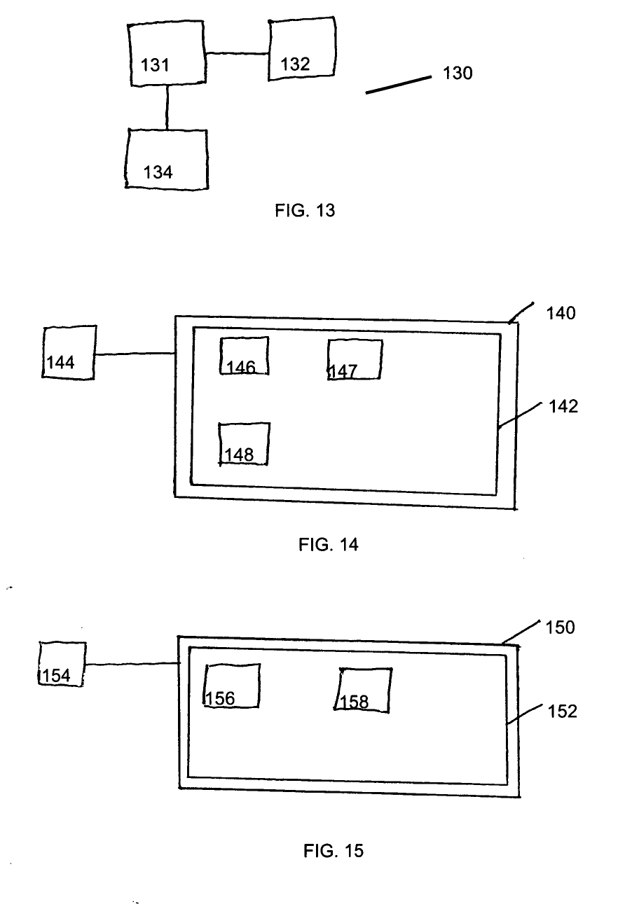

According to another embodiment of the invention as illustrated in FIG. 13, the pool tables, pool games and raised stands described above can all be simulated on a computer system 130, wherein players can play virtual pool on the computer system 130. The players communicate with a computer 131 using a user interface 132, such as a game controller, joystick or keyboard but the invention is not limited thereto. The players will use their user interfaces 132 to aim their shots and to control how hard the pool balls are hit. A list of the pool games mentioned above can be displayed on a display screen 134 of the computer system 130. The players can then select a game form the list using the user interface 132. Furthermore, the players can select the level of difficulty of the game. In the alternative, the game can begin at a simple level and advance to harder levels of play once the present level has been successfully completed. In addition, the players can be able to set various variables in the game. For example, the players can be able to select the size and shape of the playing surface, the size and shape of the raised stands, the size and shape of the indentations on the raised stands, and even the location of optional obstacles on the virtual playing surface and the invention is not limited thereto.

In another embodiment of the invention according to FIG. 14, a computer-readable medium 140 is illustrated schematically. The computer-readable medium 140 has embodied thereon a computer program 142 for simulating a pool game, for processing by a computer 144. The computer program comprises a code segment 146 for placing a plurality of pool balls in a starting position on the playing surface of the pool table, wherein the plurality of pool balls is comprised of an object ball and a plurality of different sets of pool balls; a code segment 147 for alternating turns between a plurality of players, wherein each player attempts to hit balls from a set of pool balls assigned to that player into pockets in the pool table using a pool cue and a cue ball; and a code segment 148 for hitting the object ball into an indentation on a top level of a raised stand located on the playing surface of the pool table once a player has hit all of their assigned balls into the pockets, wherein the game ends when the object ball comes to rest in the indentation on the raised stand.

In another embodiment of the invention according to FIG. 15, a computer-readable medium 150 is illustrated schematically. The computer-readable medium 150 has embodied thereon a computer program 152 for simulating a pool game, for processing by a computer 154. The computer program comprises a code segment 156 for placing a plurality of pool balls in a starting position on a playing surface of the pool table; a code segment 158 for alternating turns between a plurality of players, wherein each player attempts to hit a ball from the plurality of pool balls into an indentation on at least one raised stand located on the playing surface of the pool table by hitting a cue ball with a pool cue.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for playing a game on a pool table, comprising the steps of:
placing a plurality of pool balls in a starting position on the playing surface of the pool table, wherein the plurality of pool balls is comprised of an object ball and a plurality of different sets of pool balls;
alternating turns between a plurality of players, wherein each player attempts to hit balls from a set of pool balls assigned to that player into pockets in the pool table using a pool cue and a cue ball; and
hitting the object ball into an indentation on a top level of a raised stand located on the playing surface of the pool table once a player has hit all of their assigned balls into the pockets, wherein the game ends when the object ball comes to rest in the indentation on the raised stand.

2. The method according to claim 1, wherein players hit the object ball with the pool cue when attempting to hit the object ball into the indentation on the raised stand after the player has hit all of their assigned balls into the pockets.

3. The method according to claim 1, wherein players hit the cue ball with the pool cue when attempting to hit the object ball into the indentation on the raised stand.

4. The method according to claim 1, wherein each player during their turn can attempt to hit the object ball into the indentation on the raised stand using the pool cue to strike the cue ball.

5. The method according to claim 1, wherein each player is assigned a set of balls prior to starting the game.

6. The method according to claim 1, wherein each player is assigned a set of balls during the game.

7. The method according to claim 6, wherein players are assigned a particular set of balls when that player hits one of the balls of the set into one of the pockets.

8. The method according to claim 1, wherein a player receives another turn when that player hits one of their assigned pool balls into one of the pockets.

9. The method according to claim 1, wherein a player receives another turn when that player hits one of their assigned pool balls into the indentation on the raised stand.

10. The method according to claim 1, wherein the raised stand has sloped sides that lead to the top level and the top level has at least one indentation.

11. The method according to claim 10, wherein the raised stand can have any number of sides and shapes.

12. The method according to claim 11, wherein the shape of the raised stand is substantially similar to a circle, triangle, square, hexagon or a pentagon.

13. The method according to claim 10, wherein the at least one indentation is a dip with sloping sides.

14. The method according to claim 10, wherein the at least one indentation is a substantially circular hole with substantially vertical sides.

15. The method according to claim 1, wherein there are two players and two sets of balls.

16. The method according to claim 15, wherein there are 7 balls in each of the two sets of balls and the two sets of balls and the object ball are racked in a triangular shaped pack at the starting position.

17. The method according to claim 15, wherein there are 4 balls in each of the two sets of balls and the two sets of balls and the object ball are racked in a diamond shaped pack at the starting position.

18. The method according to claim 15, wherein there are 3 balls in each of the two sets of balls and the two sets of balls and the object ball are racked in a circular shaped pack at the starting position.

19. The method according to claim 1, wherein the raised stand is placed approximately in the center of the pool table.

20. The method according to claim 14, wherein the raised stand is approximately 4 inches in diameter and the indentation is approximately 2.75 inches in diameter.

21. The method according to claim 14, wherein the raised stand is approximately 5.5 inches in diameter and the indentation is approximately 4 inches in diameter.

22. The method according to claim 14, wherein the raised stand is approximately 7 inches in diameter and the indentation is approximately 5.5 inches in diameter.

23. The method according to claim 14, wherein the raised stand is approximately 13.5 inches in diameter and the indentation is approximately 12 inches in diameter.

24. The method according to claim 1, wherein a plurality of raised stands are located on the playing surface of the pool table.

25. The method according to claim 24, wherein the object ball can be hit into the indentation on any raised stand to win the game.

26. The method according to claim 1, wherein the raised stand is comprised of at least one of metal, metal composite, plastic, wood, glass, resin, rubber or stone.

27. The method according to claim 1, wherein the raised stand has multiple levels with multiple ramps and at least one indentation on a top level of the raised stand.

28. The method according to claim 27, wherein the raised stand has at least one indentation on multiple levels.

29. The method according to claim 1, wherein the indentation takes up a portion of the top level of the raised stand.

30. The method according to claim 1, wherein the indentation takes up substantially all of the top level of the raised stand.

31. A gaming device to be used on a playing surface of a pool table for playing a game of pool, comprising:
a raised stand located on the playing surface of the pool table, the raised stand having sloped sides that lead from the playing surface up to a top level, wherein the top level comprises an indentation in which a pool ball can come to rest after advancing up the sloped sides.

32. The gaming device according to claim 31, wherein the indentation takes up a portion of the top level of the raised stand.

33. The gaming according to claim 31, wherein the indentation takes up substantially all of the top level of the raised stand.

34. The gaming device according to claim 31, wherein the raised stand can have any number of sides and shapes.

35. The gaming device according to claim 34, wherein the shape of the raised stand is substantially similar to a circle, triangle, square, hexagon or a pentagon.

36. The gaming device according to claim 31, wherein the at least one indentation is a dip with sloping sides.

37. The gaming device according to claim 31, wherein the at least one indentation is a substantially circular hole with substantially vertical sides.

38. The gaming device according to claim 31, wherein the raised stand is placed approximately in the center of the pool table.

39. The gaming device according to claim 37, wherein the raised stand is approximately 4 inches in diameter and the indentation is approximately 2.75 inches in diameter.

40. The gaming device according to claim 37, wherein the raised stand is approximately 5.5 inches in diameter and the indentation is approximately 4 inches in diameter.

41. The gaming device according to claim 37, wherein the raised stand is approximately 7 inches in diameter and the indentation is approximately 5.5 inches in diameter.

42. The gaming device according to claim 37, wherein the raised stand is approximately 13.5 inches in diameter and the indentation is approximately 12 inches in diameter.

43. The gaming device according to claim 31, wherein a plurality of raised stands are located on the playing surface of the pool table.

44. The gaming device according to claim 31, wherein the raised stand is comprised of at least one of metal, metal composite, plastic, wood, glass, resin, rubber or stone.

45. The gaming device according to claim 31, wherein the raised stand has multiple levels with multiple ramps and at least one indentation on a top level of the raised stand.

46. The gaming device according to claim 45, wherein the raised stand has at least one indentation on multiple levels.

47. The gaming device according to claim 31, wherein the top surface of the raised stand has a plurality of indentations.

48. The gaming device according to claim 47, wherein the plurality of indentations have different sizes.

49. A pool table, comprising:
a substantially flat playing surface;
a raised bumper system surrounding the flat playing surface; and
at least one raised stand located on the playing surface, wherein the at least on raised stand has sloping sides that lead up from the playing surface to a top level, wherein the top level comprises an indentation in which a pool ball can come to rest after advancing up the sloping sides.

50. The pool table according to claim 49, wherein the playing surface has a substantially rectangular shape.

51. The pool table according to claim 49, wherein the playing surface has a substantially circular shape.

52. The pool table according to claim 49, further comprising:
a plurality of drop pockets arranged along the periphery of the playing surface.

53. The pool table according to claim 51, wherein three raised stands are located on the flat playing surface.

54. The pool table according to claim 49, wherein the at least one raised stand is detachable from the playing surface of the pool table.

55. The pool table according to claim 49, wherein the indentation takes up a portion of the top level of the raised stand.

56. The pool table to claim 49, wherein the indentation takes up substantially all of the top level of the raised stand.

57. The pool table according to claim 49, wherein the raised stand can have any number of sides and shapes.

58. The pool table according to claim 57, wherein the shape of the raised stand is substantially similar to a circle, triangle, square, hexagon or a pentagon.

59. The pool table according to claim 49, wherein the at least one indentation is a dip with sloping sides.

60. The pool table according to claim 49, wherein the at least one indentation is a substantially circular hole with substantially vertical sides.

61. The pool table according to claim 49, wherein the raised stand is placed approximately in the center of the pool table.

62. The pool table according to claim 59, wherein the raised stand is approximately 4 inches in diameter and the indentation is approximately 2.75 inches in diameter.

63. The pool table according to claim 59, wherein the raised stand is approximately 5.5 inches in diameter and the indentation is approximately 4 inches in diameter.

64. The pool table according to claim 59, wherein the raised stand is approximately 7 inches in diameter and the indentation is approximately 5.5 inches in diameter.

65. The pool table according to claim 59, wherein the raised stand is approximately 13.5 inches in diameter and the indentation is approximately 12 inches in diameter.

66. The pool table according to claim 49, wherein the raised stand is comprised of at least one of metal, metal composite, plastic, wood, glass, resin, rubber or stone.

67. The pool table according to claim 49, wherein the raised stand has multiple levels with multiple ramps and at least one indentation on the top level of the raised stand.

68. The pool table according to claim 67, wherein the raised stand has at least one indentation on multiple levels.

69. The pool table according to claim 49, wherein the top surface of the raised stand has a plurality of indentations.

70. The pool table according to claim 69, wherein the plurality of indentations have different sizes.

71. A method for playing a game on a pool table, comprising the steps of:
placing a plurality of pool balls in a starting position on a playing surface of the pool table; and
alternating turns between a plurality of players, wherein each player attempts to hit a ball from the plurality of pool balls into an indentation on at least one raised stand located on the playing surface of the pool table by hitting a cue ball with a pool cue.

72. The method according to claim 71, wherein said plurality of balls is comprised of an object ball and a plurality of different sets of balls, wherein each player is assigned a set of balls and the players alternate turns during which each player attempts to hit a ball from their assigned set of balls into the indentation one the at least one raised stand.

73. The method according to claim 72, wherein after a player has hit all of their assigned balls into the indentation on the raised stand, the player attempts to win the game by hitting the object ball into the indentation on the raised stand.

74. The method according to claim 71, wherein a raised stand is located near or covering each pocket of the pool table.

75. The method according to claim 74, wherein another raised stand is placed approximately in the center of the pool table.

76. The method according to claim 75, wherein a player must hit the object ball onto the indentation on the raised stand near the middle of the table to win the game.

77. The method according to claim 71, wherein the raised stand has sloped sides that lead to a top level and the top level has at least one indentation.

78. The method according to claim 77, wherein the raised stand can have any number of sides and shapes.

79. The method according to claim 78, wherein the shape of the raised stand is substantially similar to a circle, triangle, square, hexagon or a pentagon.

80. The method according to claim 77, wherein the at least one indentation is a dip with sloping sides.

81. The method according to claim 77, wherein the at least one indentation is a substantially circular hole with substantially vertical sides.

82. The method according to claim 81, wherein the raised stand is approximately 4 inches in diameter and the indentation is approximately 2.75 inches in diameter.

83. The method according to claim 81, wherein the raised stand is approximately 5.5 inches in diameter and the indentation is approximately 4 inches in diameter.

84. The method according to claim 81, wherein the raised stand is approximately 7 inches in diameter and the indentation is approximately 5.5 inches in diameter.

85. The method according to claim 81, wherein the raised stand is approximately 13.5 inches in diameter and the indentation is approximately 12 inches in diameter.

86. The method according to claim 71, wherein the raised stand is comprised of at least one of metal, metal composite, plastic, wood, glass, resin, rubber or stone.

87. The method according to claim 71, wherein the raised stand has multiple levels with multiple ramps and at least one indentation on the top level of the raised stand.

88. The method according to claim 87, wherein the raised stand has at least one indentation on multiple levels.

89. The method according to claim 71, wherein the indentation takes up a portion of the top level of the raised stand.

90. The method according to claim 71, wherein the indentation takes up substantially all of the top level of the raised stand.

91. The method according to claim 77, wherein said at least one raised stand has a plurality of different sized indentations on the top surface, wherein a player receives different point values for hitting a pool ball into one of the different sized indentations on the raised stand.

92. The method according to claim 91, wherein the player receives more points for hitting the ball into smaller sized indentations on the raised stand.

93. The method according to claim 77, wherein a plurality of different sized raised stands are located on the pool table, and a player receives more points for hitting a ball into the indentations on the smaller sized raised stands.

94. A computer readable medium storing code for simulating a pool game, said code comprising:
code for placing a plurality of pool balls in a starting position on the playing surface of the pool table, wherein the plurality of pool balls is comprised of an object ball and a plurality of different sets of pool balls;
code for alternating turns between a plurality of players, wherein each player attempts to hit balls from a set of pool balls assigned to that player into pockets in the pool table using a pool cue and a cue ball; and
code for hitting the object ball into an indentation on a top level of a raised stand located on the playing surface of the pool table once a player has hit all of their assigned balls into the pockets, wherein the game ends when the object ball comes to rest in the indentation on the raised stand.

95. A computer readable medium storing code for simulating a pool game, said code comprising:
code for placing a plurality of pool balls in a starting position on a playing surface of the pool table; and
code for alternating turns between a plurality of players, wherein each player attempts to hit a ball from the plurality of pool balls into an indentation on at least one raised stand located on the playing surface of the pool table by hitting a cue ball with a pool cue.
